(19) United States
(12) Patent Application Publication
(10) Pub. No.: US 2023/0257311 A1
(43) Pub. Date: Aug. 17, 2023

(54) 3D CERAMIC PRINTING

(71) Applicant: Ceramic Additive Manufacturing Ltd., Staffordshire (GB)

(72) Inventors: Kassim Juma, Staffordshire (GB); Michael William Leaney, Staffordshire (GB)

(21) Appl. No.: 18/014,990

(22) PCT Filed: Jul. 2, 2021
(86) PCT No.: PCT/GB2021/051693

§ 371 Date: Jan. 6, 2023

(30) Foreign Application Priority Data
Jul. 7, 2020 (GB) 2010432.9

(51) Int. Cl. C04B 38/00; C04B 35/64; B01D 39/20; B28B 1/00; B33Y 10/00; B33Y 80/00

(52) U.S. Cl. CPC C04B 38/0041; C04B 38/0051; C04B 35/64; B01D 39/2075; B28B 1/001; B33Y 10/00; B33Y 80/00; C04B 2235/5436; C04B 2235/6026; C04B 2235/9615; B01D 2239/1208; B01D 2239/1241; B01D 2239/10; B22C 9/086

(57) ABSTRACT

Certain examples of the present disclosure relate to a method for manufacturing a ceramic object, the method comprising: forming a ceramic structure by 3D printing the ceramic structure with a binder jetting 3D ceramic printer using a ceramic powder and an inorganic binder, wherein the ceramic powder comprises sintered ceramic material; and firing the ceramic structure to form the ceramic object.

### TECHNOLOGICAL FIELD

Examples of the present disclosure relate to 3D ceramic printing. Some examples, though without prejudice to the foregoing, relate to a method of manufacturing a ceramic object derived from binder jetting 3D printing of a ceramic structure. Certain particular examples, though without prejudice to the foregoing, relate to a method of manufacturing a ceramic foundry filter for molten metal filtration, and a ceramic foundry filter for metal filtration manufactured according to such a method.

### BACKGROUND

3D printing, also known as Additive Manufacturing, is a well-known technique for manufacturing objects. 3D printing technologies encompass various differing techniques and processes, using differing printing medium/printing materials, for synthesizing a three-dimensional object. Typically, in 3D printing, successive layers of a material are formed under computer control, for example based on a virtual 3D model or CAD design, which may enable the creation of an object of almost any shape or geometry.

Typically, in order to form a ceramic object via 3D printing, an initial ceramic structure/model is 3D printed by a 3D ceramic printer. Such an initial ceramic structure serves as a precursor to a resultant ceramic object, the resultant ceramic object being formed when the ceramic structure is sintered.

One form of 3D ceramic printer technology is binder jetting additive manufacturing/binder jetting 3D printing (also referred to as “Powder bed and inkjet” and “drop-on-powder” printing) that uses a binding agent that is selectively applied to specific portion(s) of a layer of powder, e.g. using an inkjet printer head, to help build a part in an additive layer-by-layer process.

In a typical binder jetting process, a thin layer of powder from a powder supply is spread over a build platform. One or more inkjet nozzles selectively deposit/jet droplets of a binding agent that bind the powder particles together to form a pattern that forms a layer of the part to be 3D printed. Wherever the binding agent is applied to the ceramic powder layer, the ceramic powder binds and solidifies. When the layer is complete, the build platform moves downwards, the powder supply move upwards (e.g. via a build piston that lowers the build platform and a powder feed piston that raises the powder supply) and another thin layer of powder is spread (e.g. via a levelling roller) over the build platform. This process is repeated to build up the part until the whole part is completed. After the 3D printing process, the built part, encapsulated in the powder bed, is removed from the powder bed and the loose unbound excess powder is removed/cleaned off to expose fully the completed ceramic structure. The 3D printed part, i.e. an initial ceramic structure in “green state” then needs to be fired so as to sinter, e.g. fuse/vitrify/solidify the 3D printed ceramic structure thereby forming a resultant ceramic object. The 3D printed initial ceramic structure thereby, in effect, forms a ceramic precursor structure, which, once fired/sintered, forms the resultant ceramic object.

The ceramic powder for a binder jetting 3D ceramic printer, i.e. the ceramic powder feed stock/ceramic printing material/medium, is typically manufactured by a spray dry process. In this, a dry powder is formed from a ceramic slurry by rapidly drying it with a hot gas so as to create a dry free flowing powder of particle sizes 50-100 microns that is suitable for use in binder jetting 3D ceramic printers. However, a binder jetting 3D ceramic printer using such conventional ceramic printing material to form a ceramic structure, when fired/sintered to form a resultant ceramic object may suffer from significant shrinkage, such as of the order of 40%. This may cause asymmetric deformations in the resultant ceramic object and structural weaknesses such as cracks. Accordingly, the resultant ceramic object, i.e. derived from the fired/sintered 3D printed ceramic structure, may have a poor net shape and low fidelity to the initial shape/dimensions of the 3D printed ceramic structure prior to its firing. Where the resultant ceramic object is a ceramic foundry filter, e.g. for a direct pour casting process, the shrinkage affects the filter's porosity, reducing the filter's pores per inch (PPI) reducing the filter's filtering efficiency and flow rate thereby prolong pouring time during a casting process and risking the molten metal freezing during the casting process, e.g. in the filter or in the crucible during the casting process.

Conventional 3D ceramic printing techniques are not always optimal. In some circumstances it may be desirable to provide improved binder jetting 3D ceramic printing techniques that may reduce shrinkage upon firing of a 3D printed ceramic structure to form the resultant 3D printed ceramic object. In some circumstances it may be desirable to reduce asymmetric deformations and structural weaknesses in a resultant ceramic object, i.e. derived from the fired 3D printed structure, and improve the resultant ceramic object's fidelity to the initial shape/dimensions of the 3D printed structure prior to its firing.

The listing or discussion of any prior-published document or any background in this specification should not necessarily be taken as an acknowledgement that the document or background is part of the state of the art or is common general knowledge.

One or more aspects/examples of the present disclosure may or may not address one or more of the background issues.

### BRIEF SUMMARY

The present invention is as set out in the independent claims.

According to at least some examples of the disclosure there is provided a method of manufacturing a ceramic object, the method comprising:
forming a ceramic structure by 3D printing the ceramic structure with a binder jetting 3D ceramic printer using a ceramic powder and an inorganic jetted binder, wherein the ceramic powder comprises sintered ceramic material; and
firing the ceramic structure to form the ceramic object.

According to at least some examples of the disclosure there is provided a ceramic object manufactured according to the above method.

According to at least some examples of the disclosure there is provided a ceramic foundry filter for metal filtration manufactured according to the above method.

According to at least some examples of the disclosure there are provided examples as claimed in the appended claims.

### BRIEF DESCRIPTION OF THE DRAWINGS

For a better understanding of various examples of the present disclosure that are useful for understanding the detailed description and certain embodiments of the invention, reference will now be made by way of example only to the accompanying drawings in which:

FIG. 1 schematically illustrates a method of the present disclosure;

FIG. 2 schematically illustrates another method of the present disclosure; and

FIG. 3 schematically illustrates an overview of processes of the present disclosure.

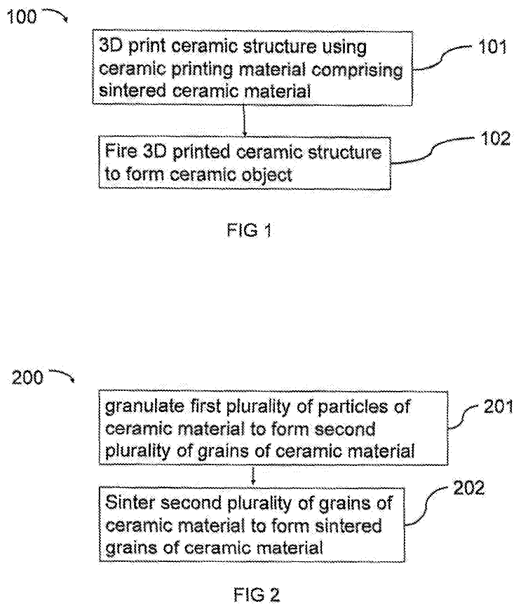

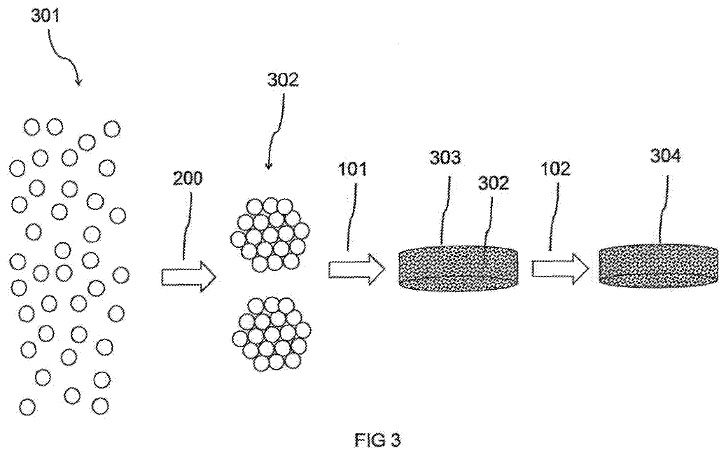

The Figures (not least with respect to FIGS. 1 and 3) schematically illustrate a method 100 of manufacturing a ceramic object 304, the method comprising:
forming 101 a ceramic structure 303 by 3D printing the ceramic structure 303 with a binder jetting 3D ceramic printer (not shown) using a ceramic powder 302 and an inorganic binder, wherein the ceramic powder 302 comprises sintered ceramic material 301; and
firing 102 the ceramic structure to form the ceramic object 304.

In examples of the disclosure, the ceramic powder for the binder jetting 3D ceramic printer (such ceramic powder being the ceramic feed stock or ceramic printing medium/material for the binder jetting 3D ceramic printer) comprises ceramic material that has already been sintered, i.e. it is ‘pre-sintered’ in that it has previously undergone a firing so as to form individual grains of ceramic material that has already been sintered/fused/vitrified. Advantageously, this decreases the porosity of the individual grains of the sintered ceramic material that makes up the ceramic powder and increases the density of the ceramic powder. Such pre-sintered grains of ceramic material forming the ceramic powder for binder jetting 3D printing are to be compared and contrasted to conventional ceramic powder for binder jetting 3D printing which comprises non-sintered (e.g. ‘green’/‘green state’ and/or non-fired ceramic material) having a relatively higher porosity).

In examples of the disclosure, when the 3D printed ceramic structure itself undergoes a firing and thereby itself become sintered/fused/vitrified to form the resultant ceramic object, the use of pre-sintered ceramic material for the ceramic powder (i.e. ceramic material that has already previously been sintered) advantageously gives rise to less shrinkage of the 3D printed ceramic structure in the formation of the resultant ceramic object following the firing than would otherwise be the case where conventional non-sintered ceramic powder is used. For instance, utilizing pre-sintered ceramic material for the ceramic powder may enable shrinkage of the 3D printed object (i.e. the green body/state 3D printed object) following its firing to be of the order of less than 10% or 5% (which is to be compared to a shrinkage of 40% for conventional ceramic powder for binder jetting 3D ceramic printing). Advantageously, this may reduce asymmetric deformations and structural weaknesses in a resultant ceramic object and improve the resultant ceramic object's fidelity to the initial shape/dimensions of the 3D printed structure prior to its firing.

Certain examples of ceramic objects that may be manufactured according to methods of the present disclosure include, not least for example, ceramic filters, such as ceramic foundry filters for filtering molten metal, in particular wherein ceramic objects with high refractory qualities (e.g. the ability to withstand temperatures in excess of 1,650° C.) as well as high structural strength/integrity are required. However, it is to be appreciated that the methods of the present disclosure are not limited to the manufacture of ceramic foundry filters and that any suitable ceramic object could be manufactured.

FIG. 1 schematically illustrates a method 100 for manufacturing a ceramic object (e.g. such as ceramic object 304 of FIG. 3).

In block 101, a ceramic structure is initially formed by 3D printing a ceramic structure using a binder jetting 3D ceramic printer. The binder jetting 3D ceramic printer uses a ceramic powder and an inorganic binder. Moreover, the ceramic powder comprises sintered ceramic material.

In various examples, the jetted material of the binder jetting 3D ceramic printer is an inorganic based binder (i.e. devoid of an organic binding agent). The inorganic binder may comprise, for example, at least one of: a ceramic binder, a Silicate, a Phosphate, an Aluminate, Aluminium Phosphate, Phosphoric acid and Alumina gel).

The 3D ceramic printer thereby prints an initial ceramic structure/model which, in effect, forms a ceramic precursor to a resultant ceramic object once it has undergone a firing process. As used herein, a “precursor” may be used to refer to a substance from which another substance is formed.

In block 102, the 3D printed ceramic structure is fired to form the ceramic object.

In some examples, the firing of the ceramic structure comprises firing the ceramic structure to a temperature greater than: 1,000° C., 1,200° C., 1,400° C., or 1,600° C. The firing temperature may be selected so as to be suitable for the ceramic material used and the refractory material therein, such materials including, not least one or more of: Silicon Carbide, Silica, clay, Alumina (Aluminium Dioxide Al₂O₃), Zirconia (Zirconium Dioxide ZrO₂), Magnesium oxide (MGO), Calcium Oxide (CaO), Mullite, Yttria/Yttrium Oxide (Y₂O₃), fused Zirconia Mullite.

In examples of the disclosure, the ceramic powder for the binder jetting 3D ceramic printer (i.e. the ceramic printing medium/material that the 3D printer uses, in combination with the jetted binder, to form the ceramic structure) comprises ceramic material that has already undergone a firing so as to form grains/granules that comprises ceramic material that has previously been sintered/fused/vitrified, i.e. particles of ceramic material have been sintered/fused/vitrified together to form grains/granules of sintered ceramic material. Such pre-sintered ceramic material has a reduced porosity and higher density as compared to non-sintered ceramic material. Using such pre-sintered ceramic material for the ceramic powder for the binder jetting 3D printer enables the 3D printed ceramic structure to undergo a reduced amount of shrinkage upon firing when forming the resultant ceramic object.

In examples of the present disclosure, the ceramic powder (i.e. ceramic printing medium/material) is a ceramic powder whose grains/particles are themselves formed of smaller particles that have been sintered together thereby forming sintered granulated ceramic material, or a sintered conglomerate of particles of ceramic material. For example, initially (before granulation and sintering) ceramic material having particles of sizes of the order of 2-50 microns, may be combined together and sintered to form sintered grains/granules having a larger particle size, e.g. of the order of 50-150 microns.

The ceramic powder may substantially comprise sintered granulated ceramic material, i.e. the sintered granulated ceramic material may comprise a substantial proportion of the ceramic powder, e.g. by weight and/or volume. For example, the sintered ceramic material may comprise 90-100% by weight of the ceramic powder. Other materials/additives that may be present in the ceramic powder (i.e. other materials/additives forming less than 10% by weight of the ceramic printing medium/material for the binder jetting 3D printer material) include: microsilica/Silica fume (which may be used to enhance the ceramic powder's absorption of the jetted binder) and clay (which may be used to enhance the green strength of the 3D printed structure).

In some examples, the sintered granulated ceramic material comprises particles/granules of sintered granulated, agglomerated or conglomerated particles of ceramic material. For example, with respect to FIG. 3, separate individual particles of ceramic material 301 may be granulated/agglomerated/conglomerated and sintered together (such granulation/agglomeration/conglomeration and sintering being schematically represented by arrow 200) to form a grains/granules/particles of sintered granulated/agglomerated/conglomerated particles of ceramic material that form the ceramic powder for a binder jetting 3D ceramic printer.

In some examples, the sintered ceramic material comprises a porosity less than 10% or 5%, i.e. the porosity of the individual grains less than 10% or 5%. Advantageously, such low porosity levels of the ceramic powder reduce the amount of shrinkage when the 3D printed ceramic structure is fired/sintered in step 102 to form the ceramic object. In some examples, the ceramic powder is configured (i.e. not least by virtue of its porosity) such that the ceramic structure 3D printed therefrom undergoes a shrinkage of less than 10% or 5% upon firing to form the ceramic object.

In some examples, the ceramic powder is configured so as to be a substantially free-flowing powder of sintered ceramic material, i.e. the grains of the ceramic powder are configured so as to substantially not be cohesive and stick together. Such a free-flowing property of the ceramic powder may be effected by the configuration of the grains/granules/particles of the sintered ceramic material, not least such as with regards to their: particle size (e.g. less than 150 microns), shape (e.g. substantially spherical), and surface characteristics (e.g. smooth and configured so as to reduce frictional forces).

In some examples, the sintered ceramic material comprises particles of sintered ceramic material having a size: less than 200 microns, less than 150 microns, less than 100 microns, or less than 50 microns.

In some examples, the sintered ceramic material comprises particles sintered ceramic material having a size: greater than 10 microns, greater than 30 microns, greater than 50, or greater than 70 microns.

An advantage of certain examples of the 3D printing process of the present disclosure, and the ceramic powder used thereby, over alternative 3D printing processes which involve carbonising a 3D printed ceramic structure (i.e. impregnating or coating the 3D printed ceramic structure with a carbon precursor, such as an organic material/carbon containing compound, and pyrolyzing the 3D printed ceramic structure [i.e. firing the 3D printed ceramic structure in the absence of air/oxygen] such that the organic material within/surrounding the 3D printed ceramic structure is carbonised thereby forming a network of carbon bonds within/surrounding the resultant ceramic object), is that the firing process 201 can be performed in the presence of oxygen. Hence a simpler and cheaper manufacturing process may be adopted that can be carried out in the open air and does not necessitate a de-oxygenated. This may also enable a continuous firing process to be utilised instead of a batch process as would be required for firing in a de-oxygenated environment. Furthermore, for alternative 3D printing processes which involve carbonising a 3D printed ceramic structure, the resultant pyrolyzed carbonised 3D printed ceramic object would oxidise in temperatures at around 600° C. Advantageously, examples of the 3D printing process of the present disclosure result in ceramic objects that do not oxidise at 600° C. This may be advantageous not least where the resultant ceramic object is a ceramic foundry filter for metal filtration, as this enables the filter to be pre-heated (thereby reducing the metal freezing upon initial impact with the filter during the metal filtration process).

FIG. 2 schematically illustrates an example of a method 200 for manufacturing ceramic powder for a 3D ceramic printer (e.g. such as ceramic printing material 302 of FIG. 3).

In block 201, a first plurality of particles of ceramic material 301 (not least for example powdered: Alumina, Silica and/or Zirconia) are granulated to form a second plurality of grains, each grain formed of a plurality of the particles 301.

In block 202, the second plurality of grains of ceramic material are sintered to form a second plurality of sintered grains of ceramic material 302. The ceramic powder thereby comprises (larger) particles (e.g. of the order of 100 microns) made up of (smaller) particles (e.g. of the order of 2-50 microns) of ceramic material sintered together such that they are ceramically bonded together. Such sintered grains of ceramic material 302 is used in examples of the present disclosure as a ceramic powder for a binder jetting 3D ceramic printer. Such sintered grains of ceramic material 302 may, in some instances, correspond to: ceramic beads or artificial sand.

FIG. 3 schematically illustrates an overview of the processes and above described methods of the present disclosure.

FIG. 3 schematically illustrates a plurality of particles of ceramic material (301) being granulated, agglomerated and/or conglomerated and then sintered to forms grains, each of which comprises a plurality of sintered particles (302). In effect, (larger) grains/granules/particles are formed from a granulation/agglomeration/conglomeration of (smaller) particles of ceramic material that are sintered together to form the larger grains/granules/particles. The granulation/agglomeration/conglomeration and sintering process is indicated by arrow 200 and corresponds to the process of FIG. 2. Such pre-sintered grains are used as ceramic powder for binder jetting 3D printing.

In some examples, initially, the not-yet-sintered particles of ceramic material (301) have particle sizes of the order of 2-50 microns. These are granulated/agglomerated/conglomerated, e.g. using water and an organic binder, to form larger granulated/agglomerated/conglomerated grains having a particle size of the order of 50-150 microns. These grains are then sintered to form sintered granulated/agglomerated/agglomerated particles of ceramic material. Following the sintering process, any grains that are larger than a threshold size (e.g. 150 microns) and less than a threshold size (e.g. 50 microns) are sieved/filtered out leaving grains having a particle size range (e.g. 50-150 microns), such particle sizes being optimal/suitable for providing a free-flowing powder and hence optimal/suitable for being used as a ceramic powder 302 for a binder jetting 3D ceramic printer. The granulation/agglomeration/conglomeration process may be configured so as to produce substantially spherical grains, such grain shapes being optimal/suitable for providing a free-flowing powder and hence optimal/suitable for being used as a ceramic powder for a binder jetting 3D ceramic printer.

The ceramic powder 302 is then used by a binder jetting 3D ceramic printer to 3D print a ceramic structure 303 formed using of the ceramic powder 302 and jetted binder. Such a printing process is indicated by arrow 101 and corresponds to the process 101 of FIG. 1.

The ceramic structure 303 is then fired to form a ceramic object 307. Such a firing process is indicated by arrow 102 of FIG. 1.

The method and processes described above may be used for manufacturing a ceramic object, not least such as a ceramic filter, for example a ceramic porous foundry filter for metal filtration, wherein an initial ceramic porous structure (similar in structure and form to that of a ceramic foundry foam filter) is printed by a 3D ceramic printer that is then fired to form the resultant ceramic foundry filter. However, it is to be appreciated that the methods of the present disclosure are not limited to the manufacture of ceramic foundry filters and that any suitable ceramic object could be manufactured, not least for example: ceramic nozzles (e.g. for metering metals), ceramic flow control devices, technical ceramics/ceramics for engineering, medical ceramics (e.g. for implants), electrics ceramics and insulators.

Examples of the present disclosure have been described using flowchart illustrations and schematic block diagrams. It will be understood that each block (of the flowchart illustrations and block diagrams), and combinations of blocks, can be implemented by any means, devices or machinery suitable for implementing the functions specified in the block or blocks. Accordingly, the blocks support: combinations of means, devices or machinery for performing the specified functions and combinations of actions for performing the specified functions.

Although features have been described with reference to certain examples, those features may also be present in other examples whether described or not. Although various examples of the present disclosure have been described in the preceding paragraphs, it should be appreciated that modifications to the examples given can be made without departing from the scope of the invention as set out in the claims. For example, various of the examples (and method processed) may be combined.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are to be interpreted as “at least one” [feature, element, component, means . . . ] unless explicitly stated otherwise.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims may be suitably combined in any manner apparent to one of ordinary skill in the art.

1. A method of manufacturing a ceramic object, the method comprising:
forming a ceramic structure by 3D printing the ceramic structure with a binder jetting 3D ceramic printer using a ceramic powder and an inorganic binder, wherein the ceramic powder comprises sintered ceramic material; and
firing the ceramic structure to form the ceramic object, wherein the ceramic object comprises a ceramic foundry filter for metal filtration.

2. The method of claim 1, wherein the sintered ceramic material comprises sintered granulated ceramic material.

3. The method of claim 1, wherein the sintered ceramic material comprises a porosity less than 10% or 5%.

4. The method of claim 1, wherein the ceramic structure undergoes a shrinkage of less than 10% or 5% upon firing to form the ceramic object.

5. The method of claim 1, wherein the ceramic powder comprises a free-flowing powder of sintered ceramic material.

6. The method of claim 1, wherein the sintered ceramic material comprises particles of sintered ceramic material having a size: less than 200 microns, less than 150 microns, less than 100 microns, or less than 50 microns.

7. The method of claim 1, wherein the sintered ceramic material comprises particles of sintered ceramic material having a size: greater than 10 microns, greater than 30 microns, greater than 50 microns, or greater than 70 microns.

8. The method of claim 1, wherein firing the ceramic structure comprises firing the ceramic structure to a temperature greater than: 1,000° C., 1,200° C. 1,400° C., or 1,600° C.

9. (canceled)

10. (canceled)

11. A ceramic foundry filter for metal filtration manufactured according to claim 1.
